(19) United States
(12) Patent Application Publication
(10) Pub. No.: US 2024/0100754 A1
(43) Pub. Date: Mar. 28, 2024

(54) Spring Cushioned Valve Pin

(71) Applicant: Synventive Molding Solutions, Inc., Peabody, MA (US)

(72) Inventors: Vito Galati, Rowley, MA (US); Jared Wright, Gloucester, MA (US); Gerald Kredel, Peabody, MA (US)

(21) Appl. No.: 18/034,994

(22) PCT Filed: Oct. 8, 2021
(86) PCT No.: PCT/US2021/054114

§ 371 Date: May 2, 2023

(51) Int. Cl. B29C 45/28

(52) U.S. Cl. CPC B29C 45/281

(57) ABSTRACT

A resiliently compressible spring or cushion in an injection molding system that has:
(a) an upstream surface that engages against a complementary surface of a component of the system that transmits force between the cushion or spring and one or the other of a mount and a drive device interconnected to a valve pin ,
(b) a downstream surface that engages against a complementary surface of a component of the system that transmits force between the cushion or spring and a valve pin.
wherein the cushion or spring resiliently compresses under an upstream force (UF) exerted in response to engagement of a distal tip end of the valve pin with a gate surface.

### RELATED APPLICATIONS

This application claims the benefit of priority to U.S. Provisional Application Ser. No. 63/089,667 filed Oct. 9, 2020 the disclosure of which is incorporated by reference in its entirety as if fully set forth herein.

The disclosures of all of the following are incorporated by reference in their entirety as if fully set forth herein: U.S. Pat. Nos. 5,894,025, 6,062,840, 6,294,122 (7018), U.S. Pat. Nos. 6,309,208, 6,287,107, 6,343,921, 6,343,922, 6,254,377, 6,261,075, 6,361,300 (7006), U.S. Pat. Nos. 6,419,870, 6,464,909 (7031), U.S. Pat. No. 6,062,840 (7052), U.S. Pat. No. 6,261,075 (7052US1), U.S. Pat. No. 6,599,116, U.S. Pat. No. 7,234,929 (7075US1), U.S. Pat. No. 7,419,625 (7075US2), U.S. Pat. No. 7,569,169 (7075US3), U.S. Pat. No. 8,297,836 (7087) U.S. patent application Ser. No. 10/214,118, filed Aug. 8, 2002 (7006), U.S. Pat. No. 7,029,268 (7077US1), U.S. Pat. No. 7,270,537 (7077US2), U.S. Pat. No. 7,597,828 (7077US3), U.S. patent application Ser. No. 09/699,856 filed Oct. 30, 2000 (7056), U.S. Patent application Ser. No. 10/269,927 filed Oct. 11, 2002 (7031), U.S. application Ser. No. 09/503,832 filed Feb. , 15, 2000 (7053), U.S. application Ser. No. 09/656,846 filed Sep. 7, 2000 (7060), U.S. application Ser. No. 10/006,504 filed Dec. 3, 2001, (7068), International Application WO2011119791 filed Mar. 24, 2011 (7094), U.S. application Ser. No. 10/101,278 filed Mar. 19, 2002 (7070) and PCT Application No. PCT/US11/062099 (7100WO0) and PCT Application No. PCT/US11/062096 (7100WO1), U.S. Pat. No. 8,562,336, U.S. Pat. No. 8,091,202 (7097US1) and U.S. Pat. No. 8,282,388 (7097US2), U.S. Pat. No. 9,205,587 (7117U50), U.S. application Ser. No. 15/432,175 (7117US2) filed Feb. 14, 2017, U.S. Pat. No. 9,144,929 (7118US0), U.S. Publication No. 20170341283 (7118US3), U.S. Pat. No. 9,724,861 (7129US4), U.S. Pat. No. 9,662,820 (7129US3), international application WO2014172100 (7131WO0), Publication No. WO2014209857 (7134WO0), international application WO2015066004 (7140WO0), Publication No. WO2015006261 (7135WO0), International application Publication No. WO2016153632 (7149WO2), International application publication no. WO2016153704 (7149WO4), U.S. Pat. No. 9,937,648 (7135US2), U.S. Pat. No. 10,569,458 (7162US1), International Application WO2017214387 (7163WO0), International Application PCT/US17/043029 (7165WO0) filed Jul. 20, 2017, International Application PCT/US17/043100 (7165WO1), filed Jul. 20, 2017 and International Application PCT/US17/036542 (7163WO0) filed Jun. 8, 2017 and International Application WO2018129015 (7169WO0), International application WO2018148407 (7170WO0), International application WO2018148407 (7171WO0), international application WO2018175362 (7172WO0), international application WO2018194961 (7174WO0), international application WO2018200660 (7176WO0), international application WO2019013868 (7177WO0), international application WO2019100085 (7178WO0), international application WO2020176479 (7185WO0), international application WO2021/034793 (7187WO0), international application WO2021080767 (7188WO0).

### BACKGROUND OF THE INVENTION

Injection molding systems have been developed for performing injection molding cycles with valve pins driven by fluid drive or electricity driven actuators where the position of the valve pin is initially set at the beginning of an injection cycle at an initial a gate closed position by trial and error or manually. Such initial gate closed positioning can result in scarring of the gate area by the tip end of the valve pin when the injection cycle process is started and the valve pin is driven into and out of the gate area by the actuator without provision of a means by which the force of contact of the tip end of the valve pin with the gate area may be cushioned during the course of reciprocal upstream and downstream movement of the valve pin when driven by the actuator.

### SUMMARY OF THE INVENTION

In accordance with the invention there is provided a resiliently compressible cushion or spring (500) that cushions axial force (UF, DF) exerted by an actuator (42) or a valve pin (50) in an injection molding apparatus (11) comprised of an injection molding machine (1000) that injects a flow of injection fluid (IF) to a heated manifold (60) that distributes the injection fluid (IF) to a distribution channel (62), wherein the actuator (42) includes a drive device (40) interconnected to the valve pin (50) in an arrangement such that the valve pin (50) is reciprocally drivable by the drive device (40) along a linear path of travel (AA) through a flow channel (105) between upstream gate open positions and downstream gate closed positions, the flow channel (105) receiving injection fluid (IF) and terminating in a gate (100) having a gate surface (107) communicating with a cavity (902) of a mold (900), wherein the resiliently compressible cushion or spring (500) disposed between the valve pin (50) and one or the other of:
(a) a mount (200) fixedly interconnectable to the actuator (42) in an arrangement wherein the valve pin (50) is disposed along the linear path of travel (AA) for driven movement downstream into engagement with the gate surface (107) under a downstream force (DF) exerted by the drive device (40), or
(b) the drive device (40) in an arrangement wherein the valve pin (50) is disposed along the linear path of travel (AA) for driven movement downstream into engagement with the gate surface (107) under a downstream force (DF) exerted by the drive device (40),
wherein the cushion or spring (500) resiliently compresses under an upstream force (UF) exerted in response to engagement of the distal tip end (52) of the valve pin (50) with the gate surface (107).

The cushion or spring (500) typically includes:
(a) an upstream surface (500us) that engages against a complementary surface (300bs, 52ds) that transmits force between the cushion or spring (500) and one or the other or both of the mount (200) and the drive device (40),
(b) a downstream surface (500ds) that engages against a complementary surface (20us, 51us) that transmits force between the cushion or spring (500) and the valve pin (50).

The cushion or spring (500) can be disposed between the valve pin (50) and the mount (200),
the mount (200) being fixedly mounted to the heated manifold (60),
the actuator (42) and drive device (40) being mounted between the mount (200) and the heated manifold (60) and
the actuator (42), the drive device (40) and the interconnected valve pin (50) being selectively adjustable together to one or more axial positions.

The mount (200) can include an adjustment screw (300) fixedly interconnectable to and disconnectable from the actuator (42), the adjustment screw being adapted to be selectively screwable clockwise and counterclockwise (315, 317) such that the actuator (42), the drive device (40) and the interconnected valve pin (50) are selectively adjustable to the one or more axial positions.

The actuator (42) typically comprises a housing (20) and the the cushion or spring (500) can be disposed between the housing (20) and the mount (200) for resilient compression and relaxation.

The drive device (40) can comprise a piston fluid sealably housed within a chamber formed by the housing (20).

The cushion or spring (500) can be disposed between the housing (20) and the adjustment screw (300) for resilient compression and relaxation.

The mount (200) is typically fixedly mounted to the heated manifold (60) via rails (250), the actuator (42) being mounted on the rails (250) and adapted to be axially slidable (AA) along the rails.

The cushion or spring (500) typically includes an upstream surface (500us) that engages against a complementary surface (300bs, 52ds) of an intermediate body (300, 52) that is fixedly interconnected to or interengaged with one or the other of the mount (200) and the drive device (40).

The cushion or spring (500) typically includes a downstream surface (500bs) that engages against a complementary surface (20us, 51us) of an intermediate body (20, 51) that is interconnected to or interengaged with the valve pin (50) in an arrangement that transmits upstream force (UF) from the valve pin (50) to the downstream surface (500bs).

The mount (200) can include an adjustment screw (300) fixedly interconnectable to and disconnectable from the actuator (42), the adjustment screw being selectively screwable clockwise and counterclockwise (315, 317) such that the actuator (42), the drive device (40) and the interconnected valve pin (50) are selectively slidable upstream and downstream along the rails (250) to one or more axial positions.

The cushion or spring (500) typically resiliently compresses under an upstream force (UF) exerted against or transmitted to a downstream surface (500bs) of the cushon or spring (500) in response to engagement of the distal tip end (52) of the valve pin (50) with the gate surface (107) under a downstream force (DF) exerted on or transmitted to the valve pin (50) or tip end (52) by the drive device (40).

The drive device (40) can be interconnected at a downstream end to a pin coupler (80) and the cushion or spring (500) is fixedly interconnectable to an upstream end (50h) of the valve pin (50) in an arrangement wherein the cushion or spring (500) together with the upstream end (50h) of the valve pin (50) is readily radially insertable into and readily radially removable from a complementary receiving recess (83) of the pin coupler (80), the pin coupler (80) recess (83) being adapted to receive and retain the cushion or spring (500) together with the interconnected upstream end (50h) of the valve pin (50) in an arrangement wherein the cushion or spring (500) is disposed between the upstream end of the valve pin (50) and the drive device (40) and such that the cushion or spring (500) is resiliently compressible within the pin coupling (80) on transmission of an upstream force (UF) from the valve pin (50) to a downstream surface (500bs) of the cushion or spring (500).

In another aspect of the invention there is provided a method of cushioning force (DF) between the gate surface (107) and the distal tip end (52) of the valve pin of the device of any of the foregoing claims comprising operating a device according to any of the foregoing claims to drive the tip end (52) into engagement with the gate surface (107).

In another aspect of the invention there is provided a method of cushioning force (DF) exerted on a gate surface (107) by the tip end (52) of a valve pin (50) in an injection molding apparatus (11) comprised of an injection molding machine (1000) that injects a flow of injection fluid (IF) to a heated manifold (60) that distributes the injection fluid (IF) to a distribution channel (62), wherein the actuator (42) includes a drive device (40) interconnected to the valve pin (50) in an arrangement such that the valve pin (50) is reciprocally drivable by the drive device (40) along a linear path of travel (AA) through a flow channel (105) between upstream gate open positions and downstream gate closed positions, the flow channel (105) receiving injection fluid (IF) and terminating in a gate (100) having a gate surface (107) communicating with a cavity (902) of a mold (900),
wherein the method comprises disposing a resiliently compressible cushion or spring (500) between the valve pin (50) and one or the other of:
(a) a mount (200) that is fixedly interconnected to the actuator (42) in an arrangement that disposes the valve pin (50) along the linear path of travel (AA) for driven movement downstream into engagement with the gate surface (107) under a downstream force (DF) exerted by the drive device (40),
(b) the drive device (40) that is adapted to drive the valve pin (50) along the linear path of travel (AA) downstream into engagement with the gate surface (107) under a downstream force (DF) exerted by the drive device (40),
wherein the cushion or spring (500) resiliently compresses under an upstream force (UF) exerted in response to engagement of the distal tip end (52) of the valve pin (50) with the gate surface (107).

In another aspect of the invention there is provided a resiliently compressible spring or cushion (500) that cushions axial force (UF, DF) exerted by an actuator (42) or a valve pin (50) in an injection molding apparatus (11) comprised of an injection molding machine (1000) that injects a flow of injection fluid (IF) to a heated manifold (60) that distributes the injection fluid (IF) to a distribution channel (62), wherein the actuator (42) includes a drive device (40) interconnected to the valve pin (50) in an arrangement such that the valve pin (50) is reciprocally drivable by the drive device (40) along a linear path of travel (AA) through a flow channel (105) between upstream gate open positions and downstream gate closed positions, the flow channel (105) receiving injection fluid (IF) and terminating in a gate (100) having a gate surface (107) communicating with a cavity (902) of a mold (900),
wherein the resiliently compressible cushion or spring (500) includes:
(a) an upstream surface (500us) that engages against a complementary surface (300bs, 52ds) that transmits force between the cushion or spring (500) and one or the other of the mount (200) and the drive device (40),
(b) a downstream surface (500ds) that engages against a complementary surface (20us, 51us) that transmits force between the cushion or spring (500) and the valve pin (50).
wherein the cushion or spring (500) resiliently compresses under an upstream force (UF) exerted in response to engagement of a distal tip end (52) of the valve pin (50) with the gate surface (107).

In such an apparatus the cushion or spring (500) typically includes an upstream surface (500us) that engages against a complementary surface (300bs, 52ds) of an intermediate body (300, 52) that is fixedly interconnected to or interengaged with one or the other of the mount (200) and the drive device (40), and,
wherein the cushion or spring (500) includes a downstream surface (500bs) that engages against a complementary surface (20us, 51us) of an intermediate body (20, 51) that is interconnected to or interengaged with the valve pin (50) in an arrangement that transmits upstream force (UF) from the valve pin (50) to the downstream surface (500bs).

In another aspect of the invention there is provided a method of cushioning force (DF) between the gate surface (107) and the distal tip end (52) of the valve pin of the cushion or spring described above comprising operating a cushion or spring described above to drive the tip end (52) into engagement with the gate surface (107).

In another aspect of the invention there is provided an injection molding apparatus (11) comprised of an injection molding machine (1000) that injects a flow of injection fluid (IF) to a heated manifold (60) that distributes the injection fluid (IF) to a distribution channel (62), wherein the actuator (42) includes a drive device (40) interconnected to the valve pin (50) in an arrangement such that the valve pin (50) is reciprocally drivable by the drive device (40) along a linear path of travel (AA) through a flow channel (105) between upstream gate open positions and downstream gate closed positions, the flow channel (105) receiving injection fluid (IF) and terminating in a gate (100) having a gate surface (107) communicating with a cavity (902) of a mold (900),
the apparatus further comprising a resiliently compressible cushion or spring (500) disposed between the valve pin (50) and one or the other of:
(a) a mount (200) fixedly interconnected to the actuator (42) in an arrangement wherein the valve pin (50) is disposed along the linear path of travel (AA) for driven movement downstream into engagement with the gate surface (107) under a downstream force (DF) exerted by the drive device (40), or
(b) the drive device (40) in an arrangement wherein the valve pin (50) is disposed along the linear path of travel (AA) for driven movement downstream into engagement with the gate surface (107) under a downstream force (DF) exerted by the drive device (40),
wherein the cushion or spring (500) resiliently compresses under an upstream force (UF) exerted in response to engagement of the distal tip end (52) of the valve pin (50) with the gate surface (107).

In another aspect of the invention there is provided a method of cushioning force (DF) between the gate surface (107) and the distal tip end (52) of the valve pin of cushion or spring 500 described above comprising operating a cushion or spring 500 described above to drive the tip end (52) into engagement with the gate surface (107).

The cushion or spring (500) can be adapted to be loaded or compressed with a selected amount or degree of compression force (PUF). The cushion or spring (500) can further comprise a bushing 307 that is axially adjustable to engage the cushion or spring (500) and exert the selected amount or degree of compression force (PUF) against a selected engagement surface (500bs, 500us) of the cushion or spring (500) such that the cushion or spring (500) is compressed by exertion of the selected amount or degree of compression force (PUF).

### BRIEF DESCRIPTION OF THE DRAWINGS

The accompanying drawings contain numbering of components and devices that correspond to the numbering appearing in the following Summary.

FIG. 1 is a side schematic sectional view of a prior art injection molding apparatus having a fluid driven actuator interconnected to a valve pin in an arrangement where the valve pin is arranged for upstream downstream movement through a downstream nozzle flow channel where the axial position of the valve pin is manually selected to be disposed at the beginning of an injection cycle such that the tip end of the valve pin is disposed within a complementarily configured gate leading to a mold cavity such that the gate is initially closed at the beginning or start time of an upcoming injection cycle.

FIG. 2 is a closeup view of the actuator assembly shown in the FIG. 1 prior art apparatus showing the arrangement and interconnections of an actuator drive mechanism to a valve pin and a valve pin position adjustment device that is included in the assembly.

FIG. 3 is a side sectional view of an example of an apparatus according to the invention where an apparatus similar to the FIGS. 1, 2 configuration include a force or spring cushioning device that absorbs or cushions upstream axial force that may be exerted on the valve pin as a result of contact between the tip end of the valve pin and the gate area of the distal end of the nozzle or the mold. In the FIG. 3 embodiment the valve pin is cylindrical in configuration at the tip end and the actuator and valve pin are shown in the start of injection cycle, fully downstream, gate closed positions.

FIG. 4 is a view similar to FIG. 3 showing a valve pin having a conical tip end configuration and a complementarily configured gate area and showing the actuator and valve pin disposed in a fully upstream end of stroke gate open position .

FIG. 5 is a view similar to FIG. 4 showing the actuator and the valve pin disposed in a close to fully downstream gate closed position with the tip end 52 of the valve pin 50 making initial contact with the gate area 107 before the spring cushion device 500 is fully compressed as a result of upstream force UF, PF exerted on the spring cushion device 500 that results from opposing downstream force DF, PAF exerted between the tip end surface 52 of the pin and the gate area 107 as a result of partial downstream force PAF exerted by the controllably driven actuator piston or drive member 40 on the valve pin 50.

FIG. 6 is a view similar to FIG. 4 showing the actuator and the valve pin disposed in a fully downstream gate closed position with the tip end 52 of the valve pin making contact with the gate area 107 to cause the spring cushion device 500 to be fully compressed as a result of upstream force FUF, FF exerted on one engagement surface 500ds of the spring cushion device 500 that results from opposing downstream force DF, FAF exerted between the tip end surface 52 of the pin and the gate area 107 as a result of the downstream force DF, FAF exerted by the controllably driven actuator piston 40 on the valve pin 50.

FIG. 7 is a perspective view of a subassembly of components of the FIGS. 3, 4, 5, 6 assemblies showing a final step in use of a mounting plate and pin position adjustment device where a position adjustment screw is fixedly attached to the actuator housing causing the housing to axially slide on the rails to a fixed axial position determined by a previous step of rotating the adjustment screw within the mounting plate.

FIG. 8 is a top perspective exploded view of the force or spring cushion device incorporated together with the assembly of the pin position adjustment device and actuator of the FIGS. 3, 4, 5, 6, 7 assemblies.

FIG. 9 is a side schematic closeup sectonal view of an alternative embodiment of the force or spring cushion device shown in the FIGS. 3, 4, 5, 6, 7, 8 assemblies showing the force or spring cushion device 500 retained within an actuator mount by a preload compression bushing that is adjustable to exert a selectable amount of constant compression force on the spring or cushion such that the spring or cushion is compressed to a selected amount or degree.

FIG. 10 is a top perspective exploded view of the device of FIG. 9.

FIG. 11 is a schematic partial cross-sectional view of a prior art apparatus showing the use of an electric motor driven actuator interconnected to the upstream end of a valve pin having a pin head, the pin head being coupled to the drive mechanism of the actuator via a pin head adapter that enables the pin head to travel radially relative to the longitudinal axis of the valve pin as disclosed in U.S. Pat. No. 8,282,388 the disclosure of which is incorporated by reference in its entirety as if fully set forth herein.

FIG. 12 is a closeup sectional view of the pin head and pin head adaptor components of the prior art FIG. 11 apparatus.

FIG. 13 is a closeup sectional view of an apparatus according to the invention having a pin head and pin head adaptor similar to the pin head and pin head adaptor of the FIG. 11 prior art apparatus, with a force or spring cushion device disposed between the pin head and the pin head adaptor where the force or spring cushion device is in a relaxed or uncompressed state or position because the axial position of the valve pin is not in a position where the tip end of the valve pin is engaged against the gate area of the nozzle or mold.

FIG. 14 is a view similar to FIG. 13 showing the force or spring cushion device in a compressed state or position because the axial position of the valve pin is in a position where the tip end of the valve pin is engaged against the gate area of the nozzle or mold exerting an upstream force on the pin that results in compression of the force or spring cushion device.

FIG. 15 is a top side perspective view of the FIGS. 13, 14 device.

FIG. 16 is a top side exploded perspective view of the FIGS. 13, 14, 15 assembly.

### DETAILED DESCRIPTION OF THE INVENTION

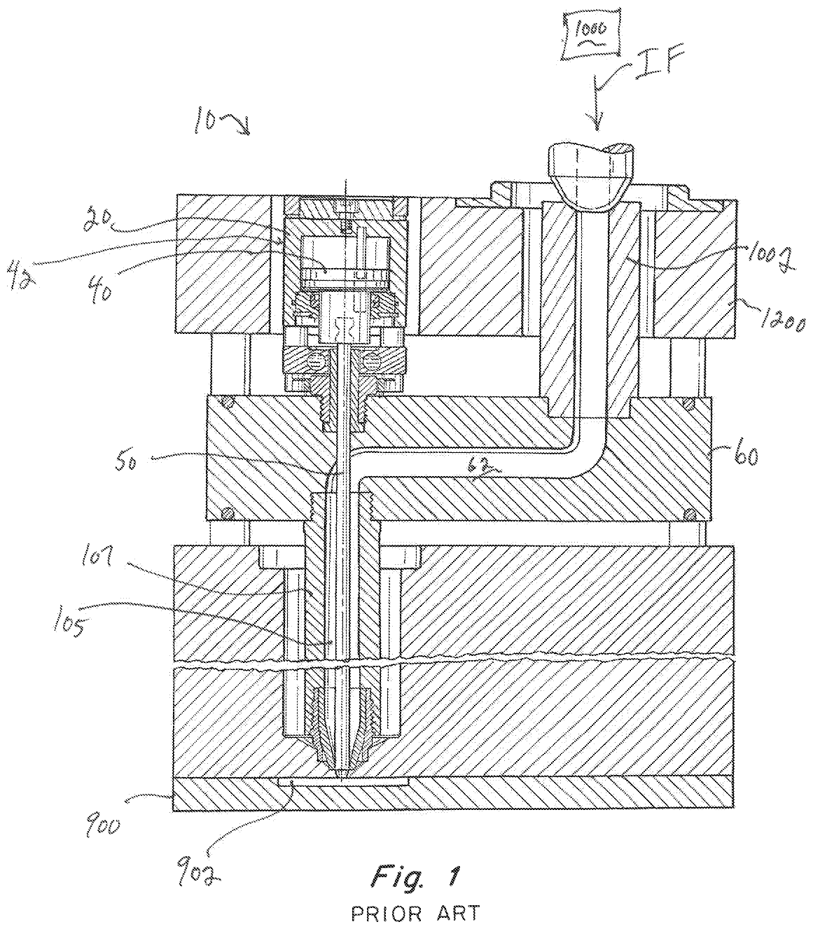

FIG. 1 shows a conventional apparatus comprised of an injection machine 1000 that injects an injection fluid IF through an inlet 1002 to a fluid distribution channel 62 disposed within a heated hotrunner or manifold 60. The distribution channel 62 communicates with a downstream fluid flow channel 105 typically disposed within a nozzle assembly 107 that has a distal end gate surface 107 of a gate 100 that leads to the cavity 902 of a mold 900. A valve pin 50 is interconnected to the drive mechanism 40 of an actuator 42 that is adapted to drive the valve pin 50 upstream and downstream along a drive axis A between gate closed and gate open positions. An apparatus according to the invention typically includes all of the conventional components as described.

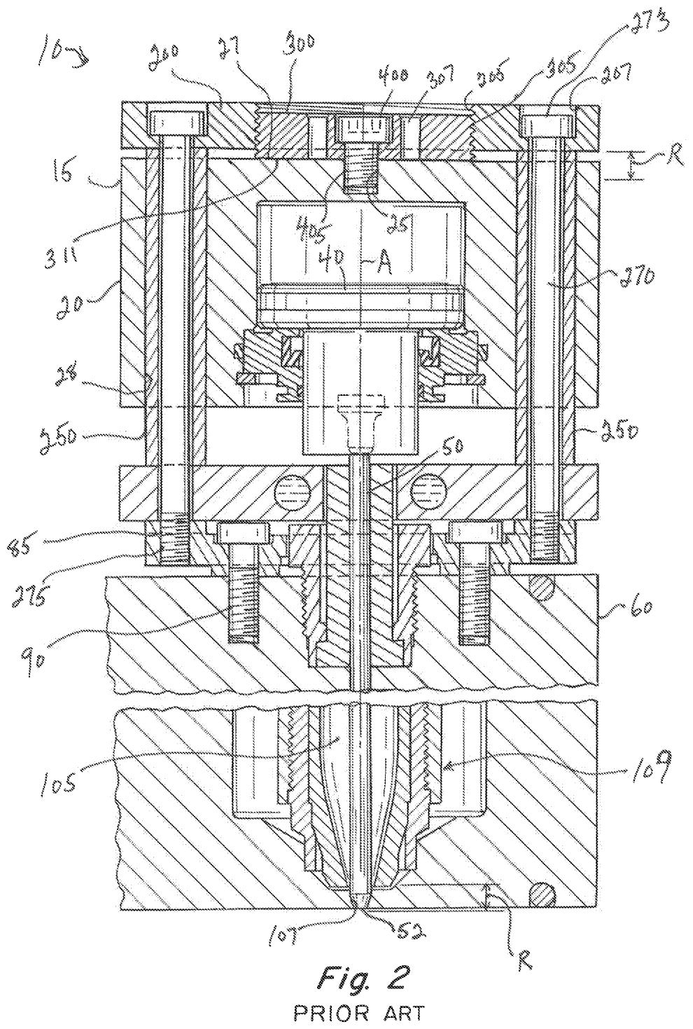

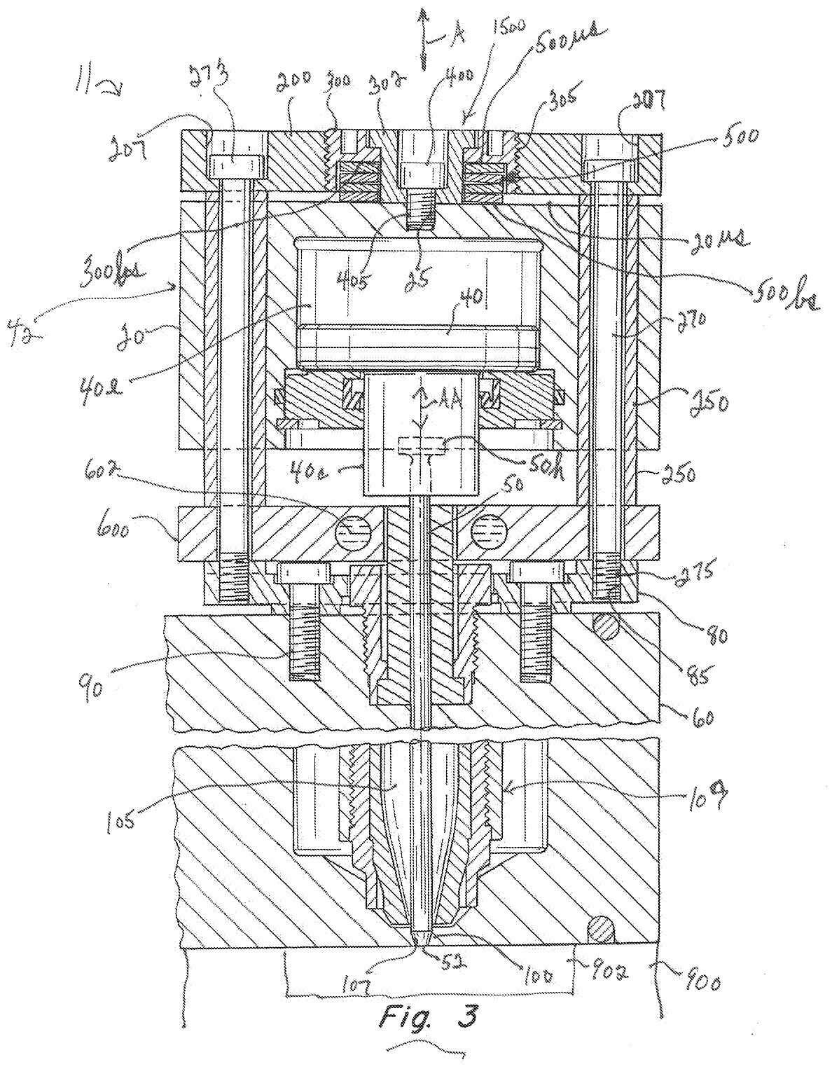

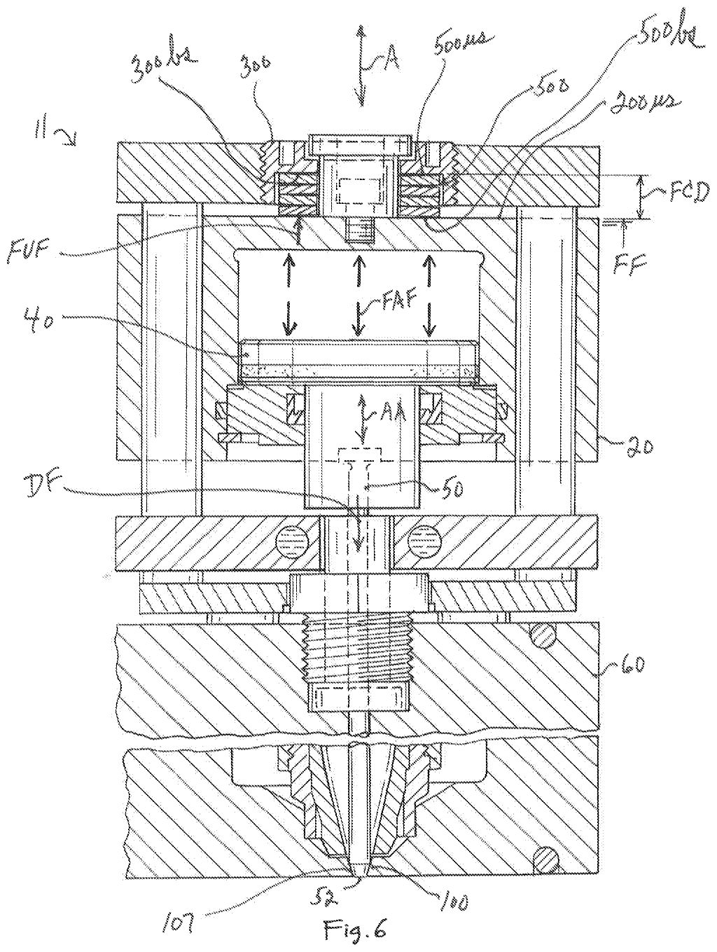

In the FIGS. 1, 2 conventional prior art apparatus, the actuator 42 shown is a fluid driven, hydraulic or pneumatic, device and the drive mechanism is a piston 40. Analogous components are shown in FIGS. 3, 4, 5, 6, 7 that show an example of an apparatus according to the invention that further includes a force or spring cushion assembly 500 according to the invention.

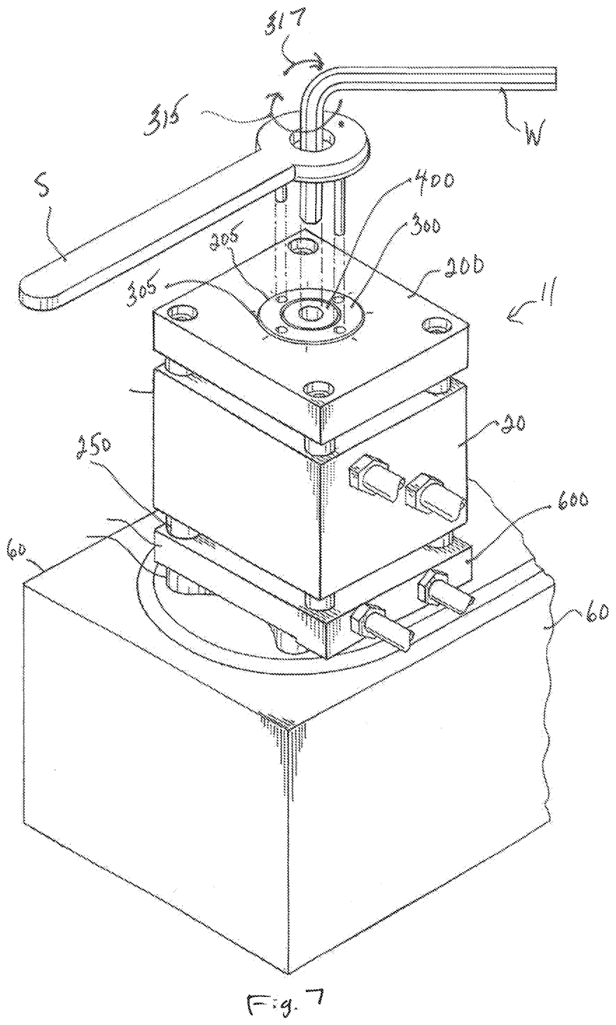

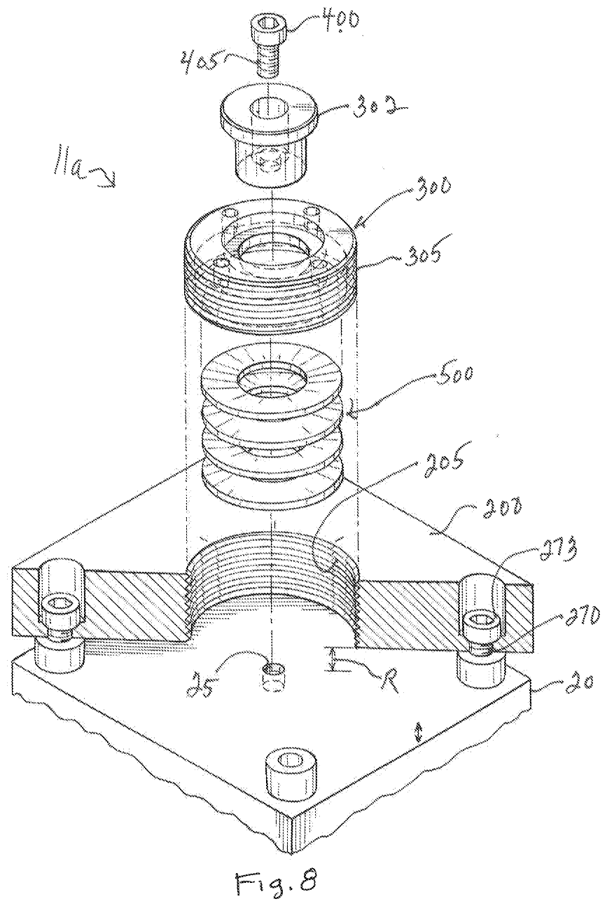

The examples of an apparatus 11 according to the invention as shown in FIGS. 3, 4, 5, 6, 7, 8 provide an assembly for adjusting the axial position A of a valve pin 50 in the larger injection molding system that includes an injection molding machine 1000 that injects molten injection fluid IF into the distribution channels 62 et al. of the heated distribution manifold or hotrunner 60. The pin adjustment assembly 1500 includes an actuator 42 comprising a housing 20 having a fluid drive chamber enclosing a piston drive member 40 that is fixedly interconnectable to the valve pin 50, the drive member 40 driving the valve pin 50 reciprocally upstream and downstream along an axial path of travel A through a fluid delivery channel 105 having an exit or gate 100 having a gate surface 107, the gate 100 leading to the cavity 902 of the mold 900. The gate 100 to the cavity 902 is reciprocally opened and closed by reciprocal downstream and upstream driven movement AA, of a distal downstream tip end 52 of the valve pin 50 into and out of the exit 100 or gate of the fluid delivery channel 105. The actuator housing 20 is slidably mounted upstream of the fluid delivery channel 105 for controlled upstream and downstream movement AA of the drive member 40 along a path complementary to the axial path of travel A of the valve pin.

The apparatus 11 includes a mounting plate 200 and an axial position adjustment screw 300 screwably mounted within the mounting plate 200 upstream of the housing 20 of the actuator 15, the adjustment screw 300 being controllably screwable clockwise 315 and counterclockwise 317 within the mounting plate 200 to move along an upstream and downstream path A complementary to the axial path of travel AA of the drive member 40 and the valve pin 50.

The path of movement or travel of the screw 300 and drive member 40 and actuator 20 can be generally parallel to path of travel AA of the valve pin 50. Or the path of movement or travel of the adjustment screw 300 and drive member 40 can be axially aligned or coincident with the path of axial travel AA of the valve pin 50.

The valve pin 50 is movable to selectable axial starting or ending injection cycle positions along the path of travel A such that the axial position of the tip end 52 of the valve pin 50 is selectively adjustable by selectable rotation 315, 317 of the adjustment screw 300. The selected starting or ending axial position of the valve pin 50 is effected by first clockwise or counterclockwise screwing 315, 317 of the adjustment screw 300 is fixed or set, fixedly interconnecting the actuator housing 20 to the adjustment screw 300 via locking bolt 400. Once the axial position of the screw 300 is set, the starting or ending injection cycle position of the valve pin 50 is correspondingly set via the interconnection of the screw 300 to the housing and the mounting of the drive member 40 within the housing 20 and the interconnection of the actuator coupling 40c to the proximal upstream disposed pin head 50h.

The drive member 40 is preferably interconnectable to and disconnectable from the valve pin 50, 50h externally of the enclosure or chamber 15c of the housing 20 of the actuator while the enclosure 40e is still enclosed not requiring disassembly of the actuator or housing 20 in order to gain access to the mechanism(s) that interconnect the pin 50 to the drive member 40.

In the FIGS. 3, 4, 5, 6, 7 embodiment the actuator 42 shown comprises a fluid driven device (hydraulic or pneumatic) having a drive member 40 comprised of a piston. In alternative embodiments the actuator 42 can comprise an electrically powered motor or actuator similarly having a housing 20 that houses an electrically driven or drive member such as a controllably rotatably drivable rotor 40r, FIG. 11 and associated electric power consuming components such as a stator 40s and linear drive member 401. Such an alternative electrically driven actuator 42 can be selectively axially adjusted in the same manner as described herein regarding a fluid driven actuator.

The FIGS. 3, 4, 5, 6, 7 embodiment further comprises a coupler 40c that interconnects the upstream end 50h of the valve pin 50 to the axial drive piston 40, the coupler 40c being accessible for interconnection and disconnection of the valve pin head 50h with and while the enclosure or chamber 40e containing the drive member 40 is still enclosed. In the FIGS. 3, 4, 5, 6, 7 embodiment, the actuator comprises a fluid driven actuator, the enclosure 40e comprising a fluid sealed chamber 40e with the piston 40 slidably mounted within the fluid sealed chamber 40e for controllably drivable upstream and downstream movement AA.

As shown the mounting plate 200 is fixedly mounted to either a fluid delivery manifold or hotrunner 60, or to a top clamping plate 1200 in an arrangement such that the adjustment screw 300 is rotatable 315, 317 to axially adjust A the valve pin 50 to selectable upstream and downstream axial positions.

As shown the manifold 60 is disposed between the mounting plate 200 and the gate 100 of the fluid delivery channel 105. The top clamp plate 1200 is typically disposed upstream of the manifold.

In the FIGS. 3, 4, 5, 6, 7 embodiment the actuator housing 20 is slidably mounted on rails 250 for axial movement AA without rotation, the rails preventing the housing 20 from rotating when the screw 300 is screwably rotated 315, 317. The top clamp plate 1200 is typically fixedly interconnected to a mold or mold plate(s) 900 containing the cavity 902 with which the gate 100 of the fluid delivery channel communicates. The heated manifold 60 delivers heated injection fluid IF to the fluid delivery channel 105.

In the FIGS. 3, 4, 5, 6, 7 embodiment, the nozzle assembly 109 is axially stationarily mounted to and assembled together with a fluid distribution manifold 60.

As shown in the FIGS. 3, 4, 5, 6, 7 embodiment, the mounting plate 200 is axially A fixed relative to the gate 100 and gate surface 107 by axially fixed interconnection to the manifold 60 and nozzle assembly 109 via axially fixed interconnection to a downstream mount 80 via bolts 270 that are axially fixedly attached between mounting plate 200 and the downstream mount 80. In turn the downstream mount 80 is axially fixed relative to gate 100 and gate surface 109 via fixed interconnection to the manifold and nozzle assembly 109 via bolts 90. As shown, a cooling plate 70 can be fixedly mounted between the actuator housing 20 and the heated manifold 60 and is supported on an upstream surface of the mount 80 that is directly attached to and in engagement with the heated manifold 60. Bolts 270 fixedly interconnect mounting plate 200 to the heated manifold 60 such that the plate 200 is axially fixed relative to the exit or gate 100. Bolts 270 attach plate 200 to mount 80 via head 273 and screw 275. The head 273 of bolts 270 are received within complementary receiving attachment recesses 207 and the threaded ends 275 of bolts 270 are received within threaded apertures 85 provided mount 80. The downstream mounting plate 80 is in turn axially fixedly mounted via bolts or pins 90 to the body of fluid distribution manifold 60. The manifold 60 is in turn axially fixedly or stationarily mounted onto nozzle assembly 109 that is axially stationarily mounted at its downstream distal end within either the manifold or the mold plates 900. Thus the mounting plate 200 is axially stationarily mounted relative to the exit port 100 of the nozzle 109, the adjustment screw 300 being selectively adjustable in the axial direction A relative to the exit port or gate 100.

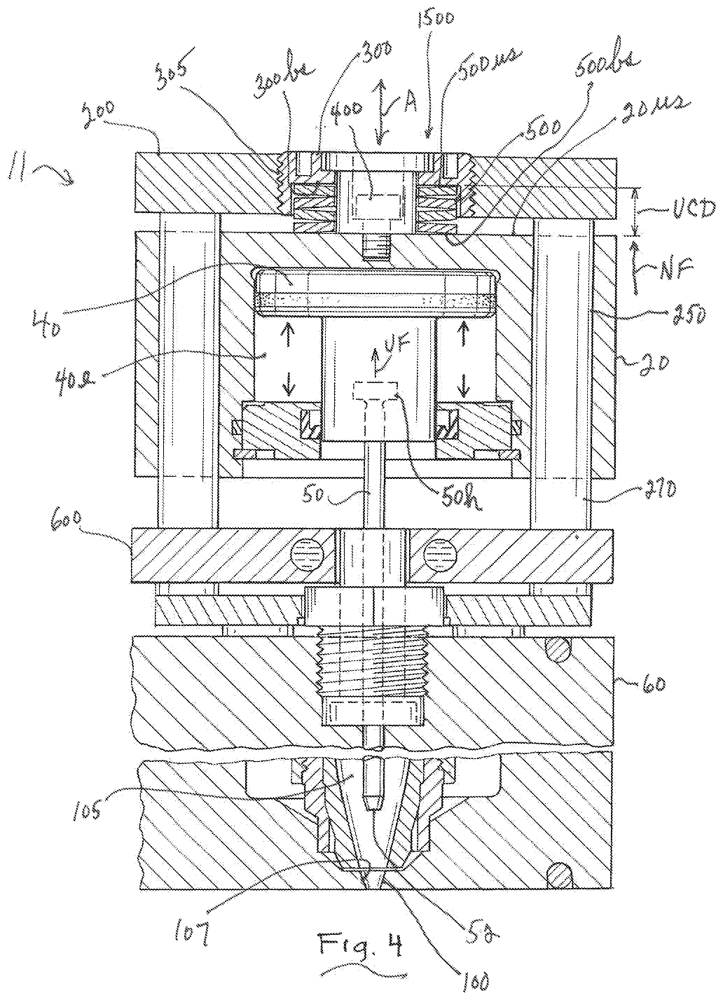

As shown the fluid driven actuator housing 20 is slidably movable upstream and downstream A along rails 250 in the axial A direction. As shown in FIG. 4, rails 250 are coaxially mounted around elongated connecting bolts or screws 270.

As shown in FIGS. 3, 4, 5, 6, 7 the actuator housing 20 is reversibly and readily fixedly connectable to and disconnectable from the adjustment screw 300 via an attachment screw 400 that has male threads 405 that are screwable within female threads 25 provided within the body of housing 20. When attachment screw 400 is screwed clockwise, housing 20 is pulled upstream to any selectable position until the the upstream top surface 20us of housing 20 eventually reaches a position where it is in compressed engagement with the downstream surface 311 of adjustment screw 300 thus fixedly connecting housing 20 axially to adjustment screw 300. When housing 20 is so connected to screw 300, the screw 300 cannot be rotated because housing 20 is rotationally fixed by virtue of its mounting on rails 250.

Once screw 300 is axially set by selective screwing 315, 317 using spanner wrench S, and housing 20 is next subsequently axially fixedly interconnected to screw 300 via screw 400 as described above or by other means, the starting and/or ending axial position of the tip end 52 of valve pin 50 is fixed for future injection cycles. The starting or ending axial injection cycle position of all of housing 20, drive member 40, valve pin 50 and the tip end 52 of the valve pin 50 are all so fixed.

Housing 20 can be disconnected from screw 300 by conversely unscrewing attachment screw 400 in a counterclockwise direction thus loosening housing 20 from compressed engagement with adjustment screw 400 and screw 300. When housing 20 is so loosened, screw 300 can be rotated or screwed via spanner screw S has teeth T that are insertable into complementary receiving apertures disposed in the upstream surface of screw 300 enabling screw 300 to be manually rotated to a selectable degree of clockwise rotation 315, FIGS. 6A, 6B or to a selected degree of counterclockwise rotation 317, FIGS. 6A, 6C. When screw 300 is rotated to a selected degree 315 or 317, screw 300 is in turn moved axially A by a corresponding selected degree of axial travel.

Depending on the selected degree of clockwise 315 or counterclockwise 317 rotation of screw 300, the axial position of screw 300 can be adjusted a selected axial distance in a downstream D or upstream U direction. Because the valve pin 50 is fixedly interconnected to the drive mechanism 40 which is, in turn, axially fixed within housing 20 during the initial pin positioning process (the housing 20 is, in turn, axially fixed to screw 300 by use of attachment screw 400, the tip end 52 of the valve pin 50 can thus be axially adjusted to a selected axial position relative to the exit port or gate 100 and gate surface 107, the exit or gate 100 being stationary relative to the mounting plate 200 in which adjustment screw 300 is mounted.

The beginning or ending axial position of the valve pin 50 and its tip end 52 are typically stationary positions, one purpose of the device, apparatus and assemblies of the invention being to enable the user to select and predetermine the precise beginning or end axial locations of the tip end 52 of the valve pin as well as to change and adjust such beginning and end positions prior to beginning an injection cycle. Thus the user can control, select and predetermine before the injection cycle is started where the beginning stationary axial AA start position and the ending axial stationary position of the tip end 52 should be to provide assurance that the tip end 52 of the valve pin will in fact engage the gate surface 107 to effect closure to fluid flow and at the same time not engage the gate surface 107 under too high a force that may scar or damage the gate surface 107.

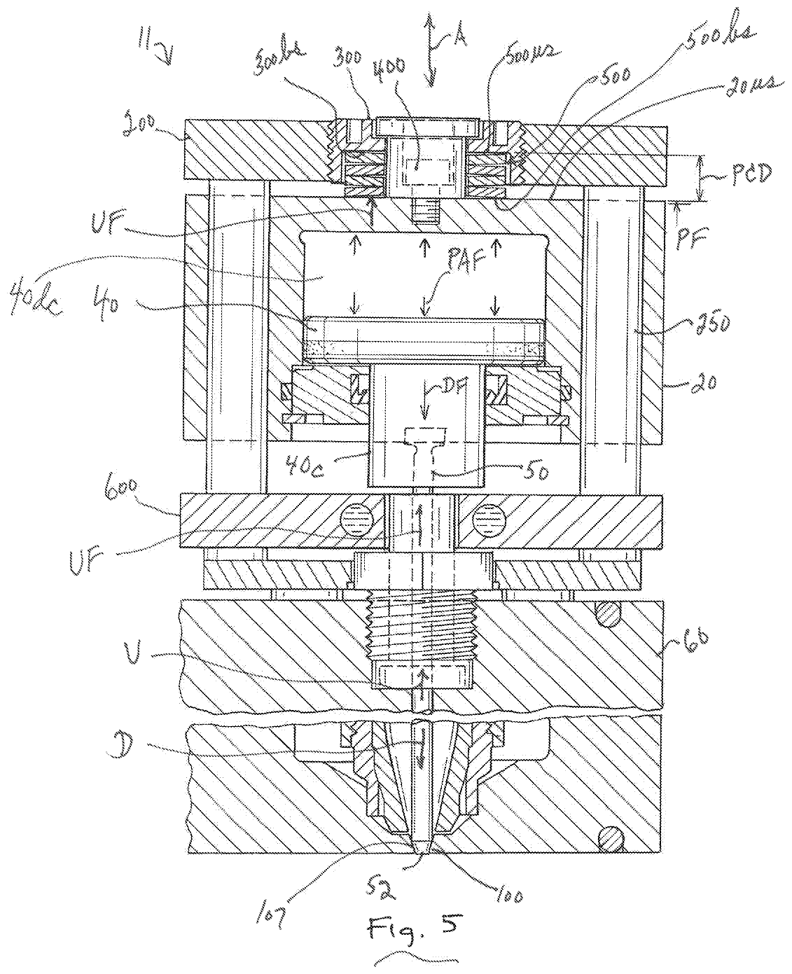

In an alternative embodiment the mounting plate 200 can be fixedly or stationarily mounted on or to a top clamping plate 1200 that is disposed upstream of the manifold 60. In such an embodiment, the coupling 40c preferably is adapted to allow the pin head 50h to travel radially R within but at the same time remain axially coupled to the coupling 40c. A coupling 40c and pin head 50h design as shown and described in U.S. Pat. No. 8,091,202 (the disclosure of which is incorporated herein by reference in its entirety), particularly with reference to FIGS. 2a, 2b, 3a, 3b therein can provide a radial travel clearance for the FIG. 5 embodiment that enables the pin 50, 50h to travel radially R a small distance within the coupling 40c that occurs on heating of the manifold 60. Such radial clearance is needed because the actuator support components 200, 250, 300 for the actuator 15, 20, 40 are radially fixed relative to the manifold which is not radially fixed but rather moves and expands slightly in the radial direction on heating. Thus on heating of the manifold 60 the pin head 50h will travel radially R a small distance together with the manifold relative to the radially fixed coupling 40c. The radial clearance provided by the coupling design described in U.S. Pat. No. 8,091,202 thus allows the pin 50h to travel radially and simultaneously remain axially coupled within coupling 40c.

In such an embodiment the top clamping plate 1200 is, in turn, stationarily mounted axially relative to the nozzle assembly 109 and the nozzle exit or gate 100, such that axial adjustment of adjustment screw 300 in upstream direction U or adjustment of screw 300 in a downstream direction D, results in a concomitant axial movement of the actuator housing 20, piston 40 and its interconnected valve pin 50 and its tip end 52 relative to axially stationary mounting plate 200 and relative to the gate 100 and gate surface 107.

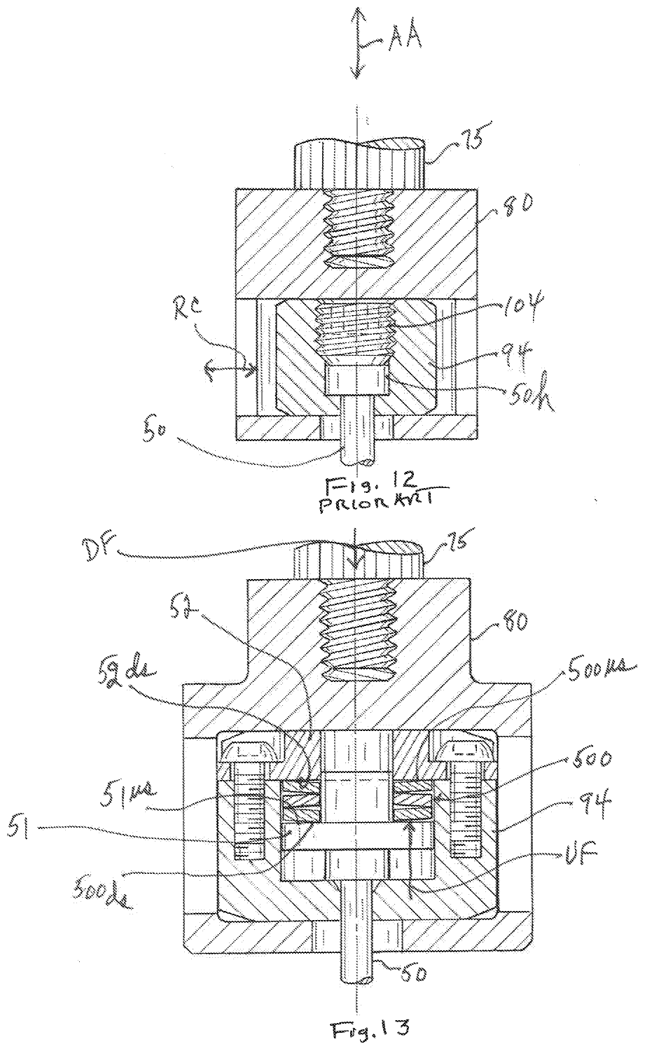

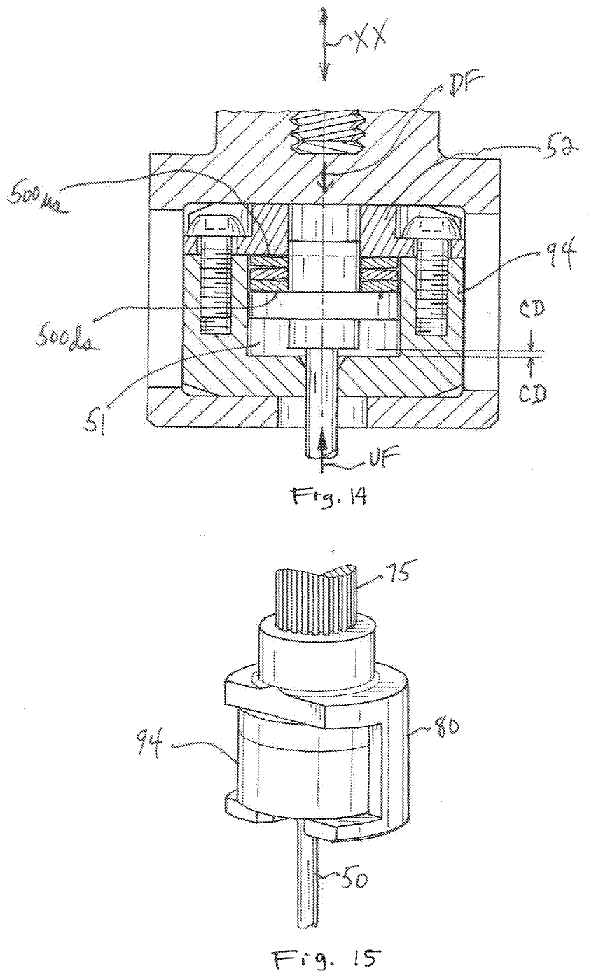

The cushion or spring 500 according to the invention can include an upstream surface 500us that can engage against a complementary surface 300bs, 52ds of an intermediate body such as the screw 300 of the FIGS. 3, 4 embodiment that is fixedly interconnected to or interengaged with the mount 200 or such as the mount 52 of the FIGS. 13, 14 embodiment that is fixedly interconnected to or interengaged with the drive device 401 in an arrangement that transmits upstream force (UF) from the spring 500 to the screw 300 or from the spring to the mount 52 to cause the spring or the cushion 500 to compress.

The cushion or spring (500) according to the invention can include a downstream surface (500bs) that engages against a complementary surface (20us, 51us) of an intermediate body such as the actuator housing body 20 of the FIGS. 3, 4 embodiment or such as the mount 51 of the FIGS. 13, 14 embodiment that are interconnected to or interengaged with the valve pin (50) in an arrangement that transmits upstream force (UF) from the valve pin (50) to the downstream surface (500bs) to cause the cushion or spring 500 to compress.

In the FIGS. 3, 4, 5, 6, 7 embodiment, a cushion or spring 500 is disposed between the mount 200 and the drive device or piston 40 of the actuator 42. As shown the cushion or spring 500 is arranged such that a downstream surface 500bs of the cushion 500 is compressibly engageable against a complementary upstream surface 20us of the housing 20 of the actuator 42. An upstream surface 500us of the cushion or spring 500 is compressibly engaged engageable against a downstream surface 300bs of the screw 300. The housing 20 is slidably mounted on the rails 250 for slidable upstream and downstream axial movement AA of the housing 20 on either or both manual axial adjustment of the housing AA by screwing 315, 317 of the screw 300 with the wrench tool S as described and also by exertion of upstreamaxial force UF on the valve pin 50 as a result of engagement of the tip end 52 of the valve pin with the gate surface 107 under downstream force.

With reference to FIG. 5, upstream force UF is exerted on the valve pin 50 and transmitted to the drive device 40 and in turn to the housing 20 when drive fluid is pumped into the fluid drive chamber 40dc driving the piston 40 downstream such that the interconnected valve pin 50 is driven axially AA downstream by the drive device or piston 40 eventually to a position where the tip end 52 of the pin 50 comes into engagement with the surface 107 of the gate 100 under an initial partial downstream force PAF, DF which in turn causes an opposing partial upstream force UF to transmit through the valve pin to the actuator housing 20 via the piston 40 causing the upstream surface 20s of the actuator housing 20 to bear against the downstream surface 500bs of the cushion or spring 500 under the initial partial force. Concomitantly the cushion or spring 500 is partially compressed by a partial compression distance PCD as shown in FIG. 5.

With reference to FIG. 6, on application of full fluid downstream force FAF within the fluid chamber 40dc, a full downstream force DF is exerted on the gate surface 107 resulting in a full opposing upstream force FUF, FF being transmitted through the valve pin 50 and housing surface 20s to the undersurface 500bs of the cushion or spring 500 by the upstream surface 20s of the axially slidable housing 20. Thus the spring or cushion 500 is fully compressed by the full compression distance FCD as shown in FIG. 6.

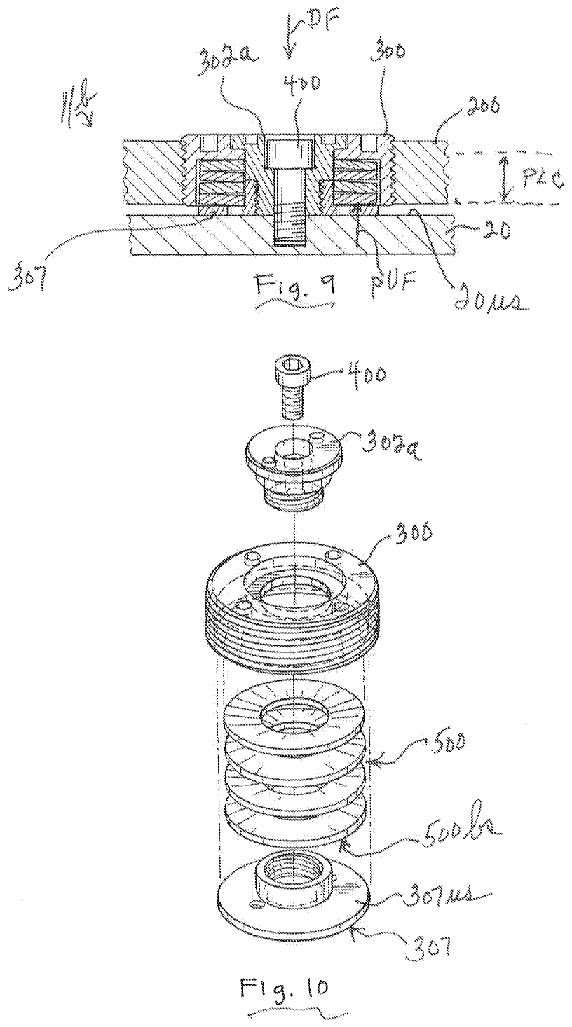

In the FIGS. 9, 10 embodiment, a preload compression bushing 307 is provided having a flange or circumferential disc portion that has a preslected thickness PLT and an upstream surface 307us for engagement with the downstream surface 500bs of the spring or cushion assembly 500. The bushing 307 is axially adjustable via selected screwing of the threads 302t of screw 302a into the threads 307t of bushing 307 to cause the upstream surface 307us to exert a selected amount of upstream force PUF on the downstream surface 500bs of the spring or cushion to effect a selected degree of compression force on the spring or cushion 500 assembly causing the spring or cushion to remain under a constant degree of compression apart from additional compression that may be exerted via upward force UF transmitted to the spring or cushion from the valve pin 50.

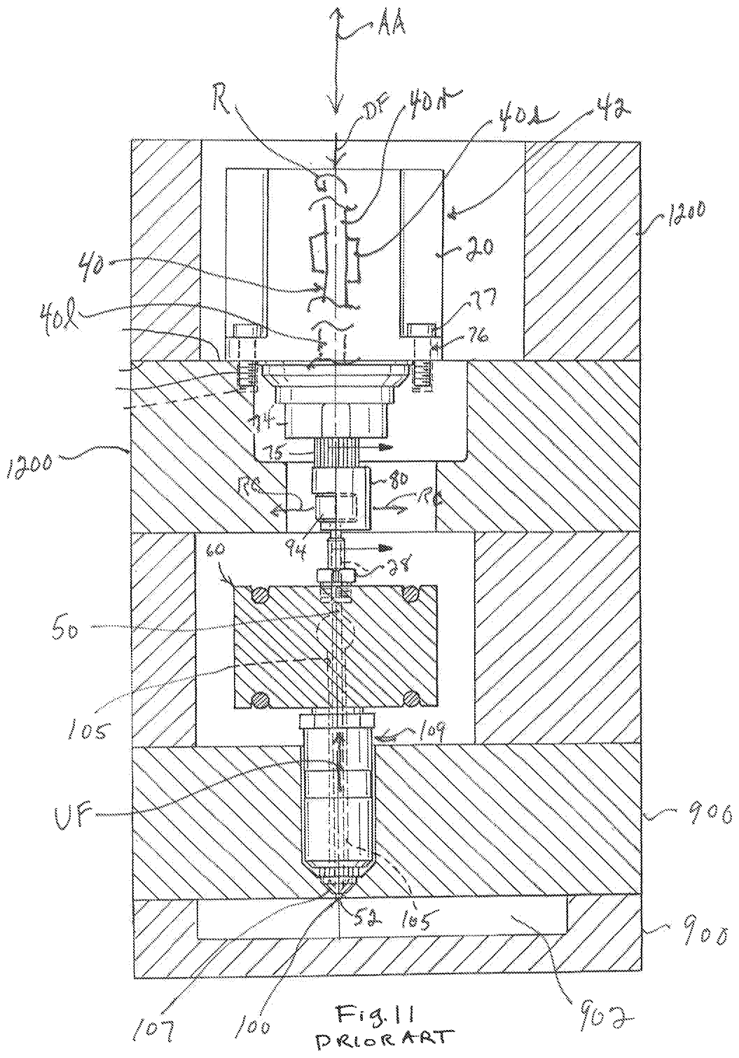

FIGS. 11, 12 show a known prior art injection molding subassembly comprised of an electric actuator 42 having a rotor 40r and stator 40s that act as the drive member to drive a valve pin 50 between gate closed and gate open positions as described above. As shown the housing 20 encases the drive member 40r, 40s and includes bores 76, one in each corner of the housing, for receiving bolts 77 that removably couple the motor housing 20 to the lower clamp plate 1200. Four complementary tapped holes are provided in the upper surface of the lower mounting plate 1200 for receiving the bolts 77 and securing the motor housing 20 to the plate. This prevents rotational and other movement of the housing of the motor with respect to the mounting plates and manifold 60 and the injection molding apparatus generally. Extending downwardly from the motor housing 20 is a cylindrical projection 74 from which the cylindrical drive shaft 75 of the motor extends. Coupled to the downstream end of the drive shaft is the actuator pin coupler 80 and extending axially downstream from the coupler 80 is the valve stem or pin 50.

As shown in FIG. 11 the electrically powered actuator typically comprises a motor comprised of a rotor 40r that is controllably drivably rotatable R by controlled transmission of electrical energy to a stator and armature 40s via a controller (not shown). The rotatably driven R rotor 40r is interconnected via a rotary to linear conversion device (not shown) to a linear drive device 401 that is controllably drivable linearly upstream and downsteam along axis AA. As shown the linear drive device 401 is interconnected to the valve pin 80 via the pin coupler 80 and its associated components such that the valve pin 80 is controllably drivable linearly upstream and downstream by and together with the linearly driven drive device 401.

FIG. 11 shows the heated manifold 60 disposed between the mounting plates 1200 and mold plates 900. In use, the mounting plates and mold plates are fixedly secured together under high clamp pressure, so as to withstand high injection molding forces. A nozzle assembly 109 extends through a bore in the lower mold plate 900, and seats and unseats to form a gate 100 to the injection mold cavity 902. The actuator housing 20 is disposed in a chamber of the upper mounting plate 1200, with a radial clearance RC provided in at least one radial direction so as to facilitate the radial coupling and decoupling of the pin head adapter 94, 104 and actuator coupler 80. Assembly and disassembly of the actuator 42, pin head 50h, pin head adapter 94, 104 and coupler is described in U.S. Pat. No. 8,091,202 the disclosure of which is incorporated by reference in its entirety as if fully set forth herein.

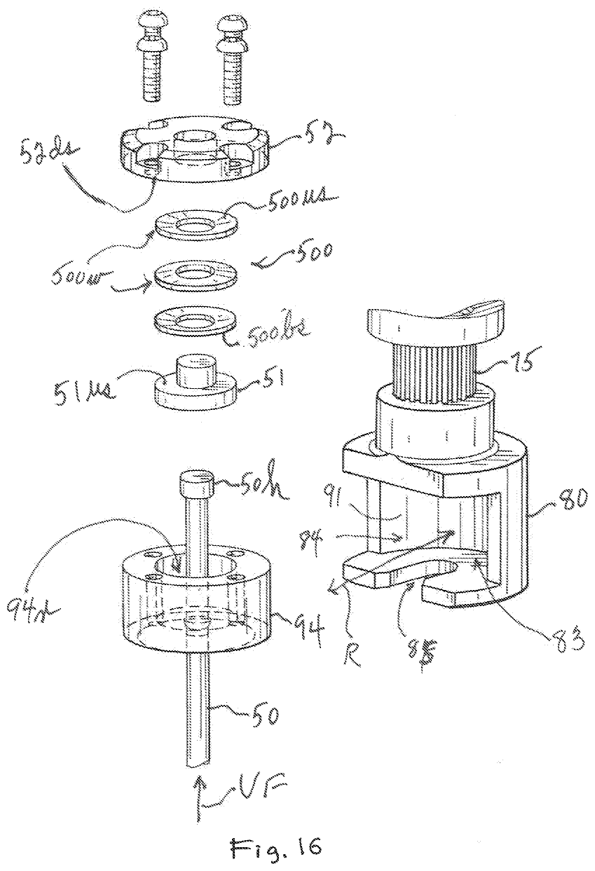

The electric actuator 42 and associated components shown in FIGS. 11, 12 can be employed in conjunction with constructing an apparatus according to the invention as shown in the FIGS. 13, 14, 15, 16 embodiment. In this embodiment, a cushion or spring 500 having opposing engagement surfaces 500us, 500ds can be mounted between the head 50h of the valve pin 50 and the actiator drive members 401, 40r in an arrangement such that any force UF exerted by the tip end 52 of the pin 50 on the surface area 107 of the gate 100 as a result of downstream force DF exerted by the drive members 401, 40r during the initial valve pin positioning phase will be absorbed by the cushion device 500.

With respect to the FIGS. 13, 14, 15, 16 embodiment, typically at the beginning of an injection cycle the actuator 42 is controllably driven such that the drive members 401, 40r exerted a downstream force DF on the coupler 80 which in turn exerts the downstream force DF on the valve pin 80 which in turn exerts the downstream force DF on the gate surface 107 via engagement of the downstream driven tip end 52 of the valve pin 50 which is itself drive downstream under the downstream force DF via the interconnection of the valve pin 50 to the downstream driven coupler 80. The engagement of the tip end 52 with the gate surface 107 under the downstream force DF causes the valve pin 50 to transmit an opposing upstream force UF to the downstream surface 51ds of the cushion or spring retaining member 51 which in turn causes the upstream surface 51us to engage and exert an upstream force UF against downstream surface 500ds of the cushion or spring 500. As a result the upstream force UF is transmitted to an upstream surface 500us of the cushion or spring 500 which in turn transmits the force UF to the downstream surface 52ds of a second retaining member 52 that in turn exerts an opposing downstream force DF on the upstream surface 500us of the cushion or spring 500 causing the cushion or spring 500 to compress a seleced compression distance CD depending on the degree of force.

As shown in FIG. 14, when the opposing forces UF and DF are exerted on the downstream 500ds and upstream 500us surfaces, the cushion or spring 500 can resiliently compress up to a selected maximum compression distance CD which simultaneously allows the valve pin 50 to travel along axis AA upstream between zero and the maximum compression distance CD thus relieving the gate surface 107 of a selected degree of added or increased pressure or force that would otherwise be exerted by the tip end surface 52 of the valve pin 50 on the gate surface 107 as a result of the initial positioning of the tip end 52 of the valve pin 50 at the beginning of an injection cycle.

Apart from compression of the cushion or spring 500 at the beginning of an injection cycle, the cushion or spring 500 can be compressed and uncompressed at any time during the course of an injection cycle depending on the degree or extent of downstream force DF exerted by the drive member 40, 401, 40r on a valve pin 80 and on the gate surface 107 when the valve pin 80 is driven to a gate closed position.

With reference to the embodiment shown in FIGS. 13, 14, 15, 16, a pin couplier 80 is attached to or mounted on the actuator shaft 75. The coupler 80 coupling includes a radial recess 83, disposed laterally (traverse to the elongated valve pin axis. The recess 83 has a radial recess opening that allows a pin head adapter 94 to be radially inserted into and removed from the radial recess. The coupling 80 also includes a radial slot 85 through which the valve stem 50 can be readily radially inserted or translated within (or removed from) the slot 85 while the adapter 94 is simultaneously radially inserted or translated within (or removed from) the radial recess 83. The coupling 80 has walls 91 that form and act as a housing for the radial recess 83 and radial slot 84. As shown, the pin connector 94 and the recess 83 and recess opening 84 are configured to have a complementary geometry, size, shape and configuration so as to enable the pin connector 94 to be received within the recess 83 and fully surrounded and contained within walls 91 and also to require that the pin connector 94 is receivable within and removable from the recess 83 only by movement of the pin connector 94 in a radial direction R, FIG. 16, transverse to the axial path of travel AA of the drive 40 and valve pin 50. The pin connector 94 is slidable by manual force along radial direction R into and out of the recess 83 and recess opening 84. As shown when the pin connector 94 is slid into and out of recess 83 and opening 84, the pin stem 31 is simultaneously slidable radially through slot opening 85 into slot 84. The walls 91 act to retain and couple the pin connector 94 and associated pin stem 50 to the shaft 75 when the connector 94 is received within recess 83 and stem 50 in slot 84.

In addition, the radial recess 83 is sized and configured to provide a radial clearance RC in all radial directions between the valve pin adapter 94 and the recess 83 when/while the adapter 94 is received and coupled within the recess 83 of the coupling 80. This radial clearance allows movement in any radial direction of the valve pin adapter while it is mounted in the recess of the actuator coupling, so as to accommodate differences in thermal expansion between various components of the injection molding apparatus such as between the manifold 60 and the mounting or top clamp plates 1200. As previously described, the valve stem 50 is mounted to a manifold 60 when the system is assembled, the manifold 60 being heated during the course of startup to a higher temperature than the relatively cold mounting plates 1200 and cold actuator 42. During the time when the manifold 60 is being heated to a higher temperature than the mounting plates and actuator, it is desirable to provide a radial clearance as described to allow the valve pin 50 and adapter 94, which is mounted to the manifold by the bushing 28 and travels radially therewith and is also being heated via the manifold 60, to move radially together with the manifold 60 with respect to the mounting plate 1200 and the axial path of travel AA of the actuator so as to prevent the application of undesirable side bending forces on the valve pin 50 and assembly 94. Such side forces can bend or break the valve stem or otherwise interfere with proper alignment and operation of the valve pin assembly and actuator.

As shown in FIG. 16 a typical spring or cushion 500 can comprise a series of compressible washers 500w that are sandwiched axially one on top of each other and mounted on and between a downstream mount 51 and an upstream mount 52 that are insertable within a complementary receiving recess 94r of the pin head adapter 94 and connectable via bolts to the adapter 94. Thus the cushion or spring 500 is readily insertable into and removable from the pin head coupler together with the adapter in a radial direction as described above.

As shown in FIG. 16, the cushion or spring 500 includes a downstream surface 500bs that engages against a complementary surface 51us of the intermediate mount 51 that is interconnected to or interengaged with the valve pin 50 via the adapter 94 in an arrangement that transmits upstream force UF that may be transmitted from the valve pin 50 as a result of engagement of the tip end 52 with the gate surface 107 to the downstream surface 500bs thus causing the spring assembly 500 to compress by a compression distance CD, FIG. 14 under influence of the upstream force UF.

What is claimed is:

1. A resiliently compressible cushion or spring (500) that cushions axial force (UF, DF) exerted by an actuator (42) or a valve pin (50) in an injection molding apparatus (11) comprised of an injection molding machine (1000) that injects a flow of injection fluid (IF) to a heated manifold (60) that distributes the injection fluid (IF) to a distribution channel (62), wherein the actuator (42) includes a drive device (40) interconnected to the valve pin (50) in an arrangement such that the valve pin (50) is reciprocally drivable by the drive device (40) along a linear path of travel (AA) through a flow channel (105) between upstream gate open positions and downstream gate closed positions, the flow channel (105) receiving injection fluid (IF) and terminating in a gate (100) having a gate surface (107) communicating with a cavity (902) of a mold (900),
wherein the resiliently compressible cushion or spring (500) disposed between the valve pin (50) and one or the other of:
(a) a mount (200) fixedly interconnectable to the actuator (42) in an arrangement wherein the valve pin (50) is disposed along the linear path of travel (AA) for driven movement downstream into engagement with the gate surface (107) under a downstream force (DF) exerted by the drive device (40), or
(b) the drive device (40) in an arrangement wherein the valve pin (50) is disposed along the linear path of travel (AA) for driven movement downstream into engagement with the gate surface (107) under a downstream force (DF) exerted by the drive device (40),
wherein the cushion or spring (500) resiliently compresses under an upstream force (UF) exerted in response to engagement of the distal tip end (52) of the valve pin (50) with the gate surface (107).

2. Apparatus according to claim 1 wherein the cushion or spring (500) includes:
(a) an upstream surface (500us) that engages against a complementary surface (300bs, 52ds) that transmits force between the cushion or spring (500) and one or the other or both of the mount (200) and the drive device (40),
(b) a downstream surface (500ds) that engages against a complementary surface (20us, 51us) that transmits force between the cushion or spring (500) and the valve pin (50).

3. Apparatus according to any of the foregoing claims wherein the cushion or spring (500) is disposed between the valve pin (50) and the mount (200),
the mount (200) is fixedly mounted to the heated manifold (60),
the actuator (42) and drive device (40) are mounted between the mount (200) and the heated manifold (60) and
the actuator (42), the drive device (40) and the interconnected valve pin (50) are selectively adjustable together to one or more axial positions.

4. Apparatus according to claim 3 wherein the mount (200) includes an adjustment screw (300) fixedly interconnectable to and disconnectable from the actuator (42), the adjustment screw being adapted to be selectively screwable clockwise and counterclockwise (315, 317) such that the actuator (42), the drive device (40) and the interconnected valve pin (50) are selectively adjustable to the one or more axial positions.

5. Apparatus according to any of the foregoing claims wherein the actuator (42) comprises a housing (20) and the the cushion or spring (500) is disposed between the housing (20) and the mount (200) for resilient compression and relaxation.

6. Apparatus according to claim 5 wherein the drive device (40) comprises a piston fluid sealably housed within a chamber formed by the housing (20).

7. Apparatus according to claim 4 wherein the the cushion or spring (500) is disposed between the housing (20) and the adjustment screw (300) for resilient compression and relaxation.

8. Apparatus according to any of the foregoing claims wherein the mount (200) is fixedly mounted to the heated manifold (60) via rails (250), the actuator (42) being mounted on the rails (250) and adapted to be axially slidable (AA) along the rails.

9. Apparatus according to any of the foregoing claims wherein the cushion or spring (500) includes an upstream surface (500us) that engages against a complementary surface (300bs, 52ds) of an intermediate body (300, 52) that is fixedly interconnected to or interengaged with one or the other of the mount (200) and the drive device (40),

10. Apparatus according to any of the foregoing claims wherein the cushion or spring (500) includes a downstream surface (500bs) that engages against a complementary surface (20us, 51us) of an intermediate body (20, 51) that is interconnected to or interengaged with the valve pin (50) in an arrangement that transmits upstream force (UF) from the valve pin (50) to the downstream surface (500bs).

11. Apparatus according to claim 9 wherein the mount (200) includes an adjustment screw (300) fixedly interconnectable to and disconnectable from the actuator (42), the adjustment screw being selectively screwable clockwise and counterclockwise (315, 317) such that the actuator (42), the drive device (40) and the interconnected valve pin (50) are selectively slidable upstream and downstream along the rails (250) to one or more axial positions.

12. Apparatus according to any of the foregoing claims wherein the cushion or spring (500) resiliently compresses under an upstream force (UF) exerted against or transmitted to a downstream surface (500bs) of the cushon or spring (500) in response to engagement of the distal tip end (52) of the valve pin (50) with the gate surface (107) under a downstream force (DF) exerted on or transmitted to the valve pin (50) or tip end (52) by the drive device (40).

13. Apparatus according to claim 1 wherein the drive device (40) is interconnected at a downstream end to a pin coupler (80) and the cushion or spring (500) is fixedly interconnectable to an upstream end (50h) of the valve pin (50) in an arrangement wherein the cushion or spring (500) together with the upstream end (50h) of the valve pin (50) is readily radially insertable into and readily radially removable from a complementary receiving recess (83) of the pin coupler (80), the pin coupler (80) recess (83) being adapted to receive and retain the cushion or spring (500) together with the interconnected upstream end (50h) of the valve pin (50) in an arrangement wherein the cushion or spring (500) is disposed between the upstream end of the valve pin (50) and the drive device (40) and such that the cushion or spring (500) is resiliently compressible within the pin coupling (80) on transmission of an upstream force (UF) from the valve pin (50) to a downstream surface (500bs) of the cushion or spring (500).

14. A method of cushioning force (DF) between the gate surface (107) and the distal tip end (52) of the valve pin of the device of any of the foregoing claims comprising operating a device according to any of the foregoing claims to drive the tip end (52) into engagement with the gate surface (107).

15. A method of cushioning force (DF) exerted on a gate surface (107) by the tip end (52) of a valve pin (50) in an injection molding apparatus (11) comprised of an injection molding machine (1000) that injects a flow of injection fluid (IF) to a heated manifold (60) that distributes the injection fluid (IF) to a distribution channel (62), wherein the actuator (42) includes a drive device (40) interconnected to the valve pin (50) in an arrangement such that the valve pin (50) is reciprocally drivable by the drive device (40) along a linear path of travel (AA) through a flow channel (105) between upstream gate open positions and downstream gate closed positions, the flow channel (105) receiving injection fluid (IF) and terminating in a gate (100) having a gate surface (107) communicating with a cavity (902) of a mold (900),
wherein the method comprises disposing a resiliently compressible cushion or spring (500) between the valve pin (50) and one or the other of:
(a) a mount (200) that is fixedly interconnected to the actuator (42) in an arrangement that disposes the valve pin (50) along the linear path of travel (AA) for driven movement downstream into engagement with the gate surface (107) under a downstream force (DF) exerted by the drive device (40),
(b) the drive device (40) that is adapted to drive the valve pin (50) along the linear path of travel (AA) downstream into engagement with the gate surface (107) under a downstream force (DF) exerted by the drive device (40),
wherein the cushion or spring (500) resiliently compresses under an upstream force (UF) exerted in response to engagement of the distal tip end (52) of the valve pin (50) with the gate surface (107).

16. A resiliently compressible spring or cushion (500) that cushions axial force (UF, DF) exerted by an actuator (42) or a valve pin (50) in an injection molding apparatus (11) comprised of an injection molding machine (1000) that injects a flow of injection fluid (IF) to a heated manifold (60) that distributes the injection fluid (IF) to a distribution channel (62), wherein the actuator (42) includes a drive device (40) interconnected to the valve pin (50) in an arrangement such that the valve pin (50) is reciprocally drivable by the drive device (40) along a linear path of travel (AA) through a flow channel (105) between upstream gate open positions and downstream gate closed positions, the flow channel (105) receiving injection fluid (IF) and terminating in a gate (100) having a gate surface (107) communicating with a cavity (902) of a mold (900),
wherein the resiliently compressible cushion or spring (500) includes:
(a) an upstream surface (500us) that engages against a complementary surface (300bs, 52ds) that transmits force between the cushion or spring (500) and one or the other of the mount (200) and the drive device (40),
(b) a downstream surface (500ds) that engages against a complementary surface (20us, 51us) that transmits force between the cushion or spring (500) and the valve pin (50).
wherein the cushion or spring (500) resiliently compresses under an upstream force (UF) exerted in response to engagement of a distal tip end (52) of the valve pin (50) with the gate surface (107).

17. Apparatus according to claim 16 wherein the cushion or spring (500) includes an upstream surface (500us) that engages against a complementary surface (300bs, 52ds) of an intermediate body (300, 52) that is fixedly interconnected to or interengaged with one or the other of the mount (200) and the drive device (40), and,
wherein the cushion or spring (500) includes a downstream surface (500bs) that engages against a complementary surface (20us, 51us) of an intermediate body (20, 51) that is interconnected to or interengaged with the valve pin (50) in an arrangement that transmits upstream force (UF) from the valve pin (50) to the downstream surface (500bs).

18. A method of cushioning force (DF) between the gate surface (107) and the distal tip end (52) of the valve pin of the device of claim 15 comprising operating a device according to claim 15 to drive the tip end (52) into engagement with the gate surface (107).

19. An injection molding apparatus (11) comprised of an injection molding machine (1000) that injects a flow of injection fluid (IF) to a heated manifold (60) that distributes the injection fluid (IF) to a distribution channel (62), wherein the actuator (42) includes a drive device (40) interconnected to the valve pin (50) in an arrangement such that the valve pin (50) is reciprocally drivable by the drive device (40) along a linear path of travel (AA) through a flow channel (105) between upstream gate open positions and downstream gate closed positions, the flow channel (105) receiving injection fluid (IF) and terminating in a gate (100) having a gate surface (107) communicating with a cavity (902) of a mold (900),
the apparatus further comprising a resiliently compressible cushion or spring (500) disposed between the valve pin (50) and one or the other of:
(a) a mount (200) fixedly interconnected to the actuator (42) in an arrangement wherein the valve pin (50) is disposed along the linear path of travel (AA) for driven movement downstream into engagement with the gate surface (107) under a downstream force (DF) exerted by the drive device (40), or
(b) the drive device (40) in an arrangement wherein the valve pin (50) is disposed along the linear path of travel (AA) for driven movement downstream into engagement with the gate surface (107) under a downstream force (DF) exerted by the drive device (40),
wherein the cushion or spring (500) resiliently compresses under an upstream force (UF) exerted in response to engagement of the distal tip end (52) of the valve pin (50) with the gate surface (107).

20. A method of cushioning force (DF) between the gate surface (107) and the distal tip end (52) of the valve pin of the device of claim 18 comprising operating a device according to claim 18 to drive the tip end (52) into engagement with the gate surface (107).

21. An apparatus (11, 11a) or a cushion or spring (500) according to any of the foregoing claims wherein the cushion or spring (500) is adapted to be loaded or compressed with a selected amount or degree of compression force (PUF).

22. An apparatus or cushion or spring (500) according to claim 21 further comprising a bushing 307 that is axially adjustable to engage the cushion or spring (500) and exert the selected amount or degree of compression force (PUF) against a selected engagement surface (500bs, 500us) of the cushion or spring (500) such that the cushion or spring (500) is compressed by exertion of the selected amount or degree of compression force (PUF).
